(19) United States
(12) Patent Application Publication
(10) Pub. No.: US 2019/0037388 A1
(43) Pub. Date: Jan. 31, 2019

(54) USER DEVICE, COMMUNICATION METHOD, AND COMPUTER STORAGE MEDIUM

(71) Applicant: NUBIA TECHNOLOGY CO., LTD., Shenzhen (CN)

(72) Inventor: Xiaodong CHE, Shenzhen (CN)

(21) Appl. No.: 16/072,729

(22) PCT Filed: Jul. 18, 2016
(86) PCT No.: PCT/CN2016/090335

§ 371 Date: Jul. 25, 2018

(30) Foreign Application Priority Data
Jan. 27, 2016 (CN) 201610055518.4

(51) Int. Cl. H04W 8/20; H04W 8/18; H04W 88/06; H04W 12/06

(52) U.S. Cl. CPC H04W 8/205; H04W 8/183; H04L 9/3226; H04W 12/06; H04W 88/06

(57) ABSTRACT

The present invention provides a user device, communication method, and computer storage medium. The method includes when a user initiates a service, sending, by an application service processor, control information to a first processor according to a service type; when the service type is implemented by the first processor, according to the control information, obtaining, by the first processor, information of one or more of a first subscriber identity card and a second subscriber identity card and communicating with a 4G network based on the information of one or more of the first subscriber identity card and the second subscriber identity card; when the service type is implemented by a second processor, according to the control information, obtaining, by the first processor, the information of one or more of the first subscriber identity card and the second subscriber identity card and sharing the information of one or more of the first subscriber identity card and the second subscriber identity card with the second processor; and communicating, by the second processor, with a 4G network based on the information of one or more of the first subscriber identity card and the second subscriber identity card.

### FIELD OF THE DISCLOSURE

The present disclosure generally relates to the field of communication technology and, more particularly, relates to a user device, communication method and computer storage medium.

### BACKGROUND

With the development of mobile communication technologies, advanced cellular networks (e.g., networks based on LTE standards (long-term evolution, standards used by some 4G networks)) are being deployed all over the world. Due to the introduction of orthogonal frequency division multiplexing (OFDM), multi-input & multi-output (MIMO), and other key technologies, use of the 4G related standards can significantly increase the spectral efficiency and the data transmission speed.

On the other hand, as network speed and band-utilization efficiency are improved, the emergence of a multi-mode user device (a user device having two subscriber identity modules, e.g., a dual-card dual-standby user device) enables users to establish data service links while implementing voice service standby.

However, the existing multi-mode user device merely enables one of the subscriber identity modules (SIMs) to use the 4G (e.g., LTE) network and its data services, while the other one subscriber identification module merely uses 3G/2G services.

Therefore, the existing user device cannot simultaneously support two subscriber identity modules using the 4G networks, which affects user experience.

### BRIEF SUMMARY OF THE DISCLOSURE

The disclosed embodiments of the present invention are intended to provide a user device, communication method, and computer storage medium, such that the user device can simultaneously support two subscriber identity modules using 4G networks.

The technical solutions adopted by the disclosed embodiments of the present invention for solving the technical issues include the following.

One aspect of the present disclosure includes a communication method, comprising:

when a user initiates a service, sending, by an application service processor, control information to a first processor according to a service type;

when the service type is implemented by the first processor, according to the control information, obtaining, by the first processor, information of one or more of a first subscriber identity card and a second subscriber identity card and communicating with a 4G network based on the information of one or more of the first subscriber identity card and the second subscriber identity card; and

when the service type is implemented by a second processor, according to the control information, obtaining, by the first processor, the information of one or more of the first subscriber identity card and the second subscriber identity card and sharing the information of one or more of the first subscriber identity card and the second subscriber identity card with the second processor; and communicating, by the second processor, with a 4G network based on the information of one or more of the first subscriber identity card and the second subscriber identity card.

In one embodiment, the information of the first subscriber identity card or the second subscriber identity card includes at least one of: a unique serial number, an international mobile subscriber identity, security authentication and encryption information, temporary information related to a local network, a user access list of services, a personal identity number (PIN), and a personal unlocking key for PIN unlocking.

In one embodiment, the service type includes at least one of: a data service performed by the first subscriber identity card, a voice service performed by the first subscriber identity card, a data service performed by the second subscriber identity card, and a voice service performed by the second subscriber identity card.

In one embodiment, when the service type is the voice service performed by the first subscriber identity card, the first processor obtains the information of the first subscriber identity card according to the control information, and establishes a 4G network voice communication connection based on the information of the first subscriber identity card.

In one embodiment, when the service type is the voice service performed by the second subscriber identity card, the first processor obtains the information of the second subscriber identity card according to the control information, and establishes a 4G network voice communication connection based on the information of the second subscriber identity card.

In one embodiment, when the service type is the data service performed by the first subscriber identity card, the first processor obtains the information of the first subscriber identity card according to the control information, and establishes a 4G network data communication connection based on the information of the first subscriber identity card.

In one embodiment, when the service type is the data service performed by the second subscriber identity card, the first processor obtains the information of the second subscriber identity card according to the control information and shares the information of the second subscriber identity card with the second processor, and the second processor establishes a 4G network data communication connection based on the information of the second subscriber identity card.

In one embodiment, the method further including: the first processor communicates with the first subscriber identity card and the second subscriber identity card every preset time-period to confirm whether the first subscriber identity card and the second subscriber identity card are in a normal communication state.

Another aspect of the present disclosure includes a user device, comprising:

an application service processor;

a first processor connected to the application service processor;

a second processor connected to the application service processor;

a first subscriber identity card connected to the first processor; and

a second subscriber identity card connected to the first processor, wherein:

when a user initiates a service, the application service processor is configured to send control information to the first processor according to a service type,

when the service type is implemented by the first processor, according to the control information, the first processor is configured to obtain information of one or more of the first subscriber identity card and the second subscriber identity card and to communicate with a 4G network based on the information of one or more of the first subscriber identity card and the second subscriber identity card,

when the service type is implemented by the second processor, according to the control information, the first processor is configured to obtain the information of one or more of the first subscriber identity card and the second subscriber identity card and to share the information of one or more of the first subscriber identity card and the second subscriber identity card with the second processor, and

the second processor is configured to communicate with a 4G network based on the information of one or more of the first subscriber identity card and the second subscriber identity card.

In one embodiment, the first processor includes a first data interface, and the second processor includes a second data interface connected to the first data interface of the first processor; and

the second processor obtains the information of one or more of the first subscriber identity card and the second subscriber identity card shared by the first processor through the second data interface.

In one embodiment, the application service processor is connected to the second processor through a universal serial bus (USB) data interface.

In one embodiment, information of the first subscriber identity card or the second subscriber identity card includes at least one of: a unique serial number, an international mobile subscriber identity, security authentication and encryption information, temporary information related to a local network, a user access list of services, a personal identity number (PIN), and a personal unlocking key for PIN unlocking.

In one embodiment, the service type includes at least one of: a data service performed by the first subscriber identity card, a voice service performed by the first subscriber identity card, a data service performed by the second subscriber identity card, and a voice service performed by the second subscriber identity card.

In one embodiment, when the service type is the voice service performed by the first subscriber identity card, the first processor is configured to obtain the information of the first subscriber identity card according to the control information, and to establish a 4G network voice communication connection based on the information of the first subscriber identity card.

In one embodiment, when the service type is the voice service performed by the second subscriber identity card, the first processor is configured to obtain the information of the second subscriber identity card according to the control information, and to establish a 4G network voice communication connection based on the information of the second subscriber identity card.

In one embodiment, when the service type is the data service performed by the first subscriber identity card, the first processor is configured to obtain the information of the first subscriber identity card according to the control information, and to establish a 4G network data communication connection based on the information of the first subscriber identity card.

In one embodiment, when the service type is the data service performed by the second subscriber identity card, the first processor is configured to obtain the information of the second subscriber identity card according to the control information and to share the information of the second subscriber identity card with the second processor, and the second processor is configured to establish a 4G network data communication connection based on the information of the second subscriber identity card.

In one embodiment, the first processor is further configured to communicate with the first subscriber identity card and the second subscriber identity card every preset time-period to confirm whether the first subscriber identity card and the second subscriber identity card are in a normal communication state.

In one embodiment, before obtaining the information of one or more of the first subscriber identity card and the second subscriber identity card shared by the first processor through the second data interface, the second processor is further configured to establish a connection with the first processor.

Another aspect of the present disclosure includes a computer storage medium, comprising: computer-executable instructions stored in the computer storage medium, wherein the computer-executable instructions are configured to execute a communication method according to any one of claims 1-8.

The user device, the communication method and the computer storage medium in the present invention may have the following beneficial effects. Dual 4G subscriber identity cards may be supported. Both a data service and a voice service of one subscriber identity card may be implemented by a first processor, a data service of the other one subscriber identity card may be implemented by a second processor, and a voice service of the other one subscriber identity card may be implemented by the first processor, improving user experience. Dual 4G data transmission services may be supported. As one card performs 4G transmission, the other one card may perform CS voice; or as one card performs 4G transmission and voice, the other one card may also perform 4G transmission, etc., greatly improving data transmission speed and user experience. Two subscriber identity cards may be simultaneously managed by the first processor, and the second processor may obtain the information of the subscriber identity card by sharing the card information. One application service processor may be needed to interact with the first processor and the second processor, thereby saving costs and improving performance.

### BRIEF DESCRIPTION OF THE DRAWINGS

The present invention is further described below with reference to the accompanying drawings and embodiments. In the drawings:

FIG. 1 illustrates a schematic diagram of a 4G network architecture consistent with disclosed embodiments of the present invention;

FIG. 2 illustrates a schematic diagram of a hardware structure of a user device consistent with disclosed embodiments of the present invention;

FIG. 3 illustrates an interaction diagram of sharing card information between a first processor and a second processor consistent with disclosed embodiments of the present invention;

FIG. 4 illustrates a format diagram of a data packet consistent with disclosed embodiments of the present invention; and

FIG. 5 illustrates a schematic flowchart of a communication method consistent with disclosed embodiments of the present invention.

### DETAILED DESCRIPTION

For clearer understanding of the technical characteristics, aims and effects of the present invention, specific embodiments of the present invention are now described in detail with reference to the accompanying drawings.

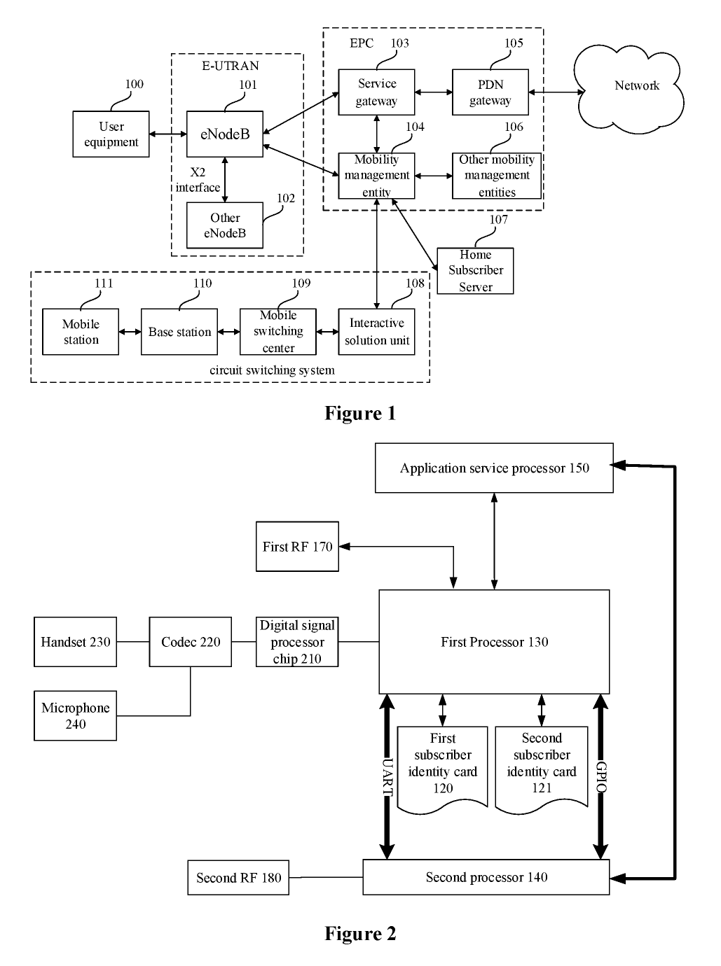

FIG. 1 illustrates a schematic diagram of a 4G network architecture consistent with disclosed embodiments of the present invention. The 4G network may be an LTE network. The 4G network architecture may include: one or more user device (i.e., user equipment or UE) 100, an Evolved UMTS Terrestrial Radio Access Network (E-UTRAN, not labeled), an Evolved Packet Core (EPC, not labeled), a Home Subscriber Server (HSS) 107, a network (e.g., Internet, not labeled), and a circuit switching system (not labeled).

The E-UTRAN may include an evolved node B (eNodeB) 101 and other eNodeBs 102. The eNodeB 101 may provide user plane and control plane protocol termination towards the user device 100. The eNodeB 101 may be connected to other eNodeBs via an X2 interface. The eNodeB 101 may be referred to as a base station, a transceiver station, a radio base station, a radio transceiver, a transceiver function, a basic service set, an extended service set, or some other suitable terminology. The eNodeB 101 may provide an access point to the EPC for the user device 100.

The eNodeB 101 may be connected to the EPC through a S1 interface. The EPC may include a mobility management entity (MME) 104, other mobility management entities 106, a service gateway 103, and a packet data network (PDN) gateway 105. The mobility management entity 104 may be a control node that handles signaling between the user device 100 and the EPC. The mobility management entity 104 may provide bearer and connection management. Entire user IP packets may be delivered through the service gateway 103, and the service gateway 103 may be connected to the PDN gateway 105. The PDN gateway 105 may provide UE IP address allocation and other functions. The PDN gateway 105 may be connected to the networks, e.g., Internet.

The circuit switching system may include an interactive solution unit (IWS) 108, a mobile switching center (MSC) 109, a base station 110, and a mobile station 111. In one aspect, the circuit switching system may communicate with the EPS through the IWS and the MME.

Referring to FIG. 2, the disclosed embodiments of the present invention may use an architecture of “a first processor+a second processor+an application service processor” to implement that the user device 100 supports both of the two subscriber identity cards residing on the 4G networks.

A first subscriber identity card 120 and a second subscriber identity card 121 may manage different users associated with different or same technical standards. In certain non-limiting examples, the technical standards may include 2G communication technologies (e.g., GSM, GPRS, EDGE), 3G communication technologies (e.g., WCDMA, TDS-CDMA), 4G communication technologies (e.g., LTE, TD-LTE), or any other mobile communication technology (e.g., 5G, 4.5G, etc.).

In one embodiment, the first subscriber identity card 120 may save information for a first 4G network communication. The second subscriber identity card 121 may save information for a second 4G network communication. Such information may include at least one of the following: a unique serial number, an international mobile subscriber identity, security authentication and encryption information, temporary information related to a local network, a user access list of services, a personal identity number (PIN), and a personal unlocking key for PIN unlocking.

In the disclosed embodiments of the present invention, a first processor 130 may be configured to perform protocol processing and configured to perform modulation and demodulation on the transmitted and received communication data to achieve communication with an external communication device.

A second processor 140 may be configured to perform protocol processing and configured to perform modulation and demodulation on the transmitted and received communication data to achieve communication with an external communication device.

In one embodiment of the present invention, the protocol processing may include a protocol stack that executes a network standard for processing various network interactions, e.g., protocol codes defined in LTE/WCDMA/GSM/TDSCDMA/1X/CDMA/EVDO and other communication standards. These standard protocols may be mandatory for the user device 100 to interact with operator's network (e.g., surfing the Internet via data, calling via VOLTE, or calling via CS circuit domain, etc.).

In one embodiment of the present invention, the first processor 130 may be implemented by a modem chip, and the second processor 140 may be implemented by a modem chip.

The first modem processor 130 may include at least one data interface, e.g., a universal input/output (I/O) interface, a universal asynchronous receiver/transmitter (UART) interface, a universal serial bus (USB) interface, and an I2C interface, etc. The second processor 140 may also include at least one data transmission interface, e.g. a universal I/O interface, a UART interface, a USB interface, and an I2C interface, etc. Referring to FIG. 2, an application service processor may be connected to the second processor 140 through a USB data interface. The first processor 130 may be connected to the second processor 140 through a universal I/O interface, a UART data interface, etc.

Considering that the download speed of the 4G network is substantially fast (150 Mbps), to achieve immediate delivery (without buffering) for the data of the second processor 140, a high-speed data transmission interface may need a sufficient bandwidth and data transmission capability. A USB interface may be a high-speed data transmission interface.

The universal I/O interface may be used as a status detection interface by identifying high/low of levels or pulses. For example, the first processor 130 may detect whether the second processor 140 is in a crash state via the high/low state of the level of the status detection pin.

The UART interface may be a serial communication interface, and configured to transmit a control signal, a status signal, and other basic information.

The first processor 130 may be connected to the first subscriber identity card 120 and the second subscriber identity card 121 through a UART interface, respectively, to obtain card information from the first subscriber identity card 120 and the second subscriber identity card 121.

In addition, the first processor 130 may be connected to the second processor 140 through a UART interface to transmit the card information to the second processor 140.

The first processor 130 may be implemented by a modem chip, and the second processor 140 may be implemented by a modem chip.

In the disclosed embodiments of the present invention, network data may be transmitted through a high-speed USB data interface at a high speed to meet data transmission demands. When no network data needs to be transmitted, low-power low-speed data interfaces may be used to transmit information, thereby ensuring data transmission and saving power consumption.

After the first processor 130 obtains the information of the first subscriber identify card 120 and the second subscriber identify card 121 through data interfaces, the first processor 130 may perform network search and registration, authentication, and other operations according to the obtained information.

The application service processor 150 may be configured to process complicated logical operations and perform task assignment, to provide interactive interfaces for the user, and to transmit the operation instructions inputted by the user (e.g., an operation instruction for accessing the Internet or making a phone call inputted by the user via a user interface) to the first processor 130. The application service processor 150 may execute an operating system of the user device 100. The operating system may be stored in a memory, and the operating system may include but not limited to Windows, Linux, Unix, Mac OS X, IOS, Solaris, and Android, etc.

In one embodiment, the user device 100 may further include a first radio frequency 170 and a second radio frequency 180. Both the first radio frequency 170 and the second radio frequency 180 may be configured to perform up-conversion, down-conversion, filtering, amplifying, transmitting, and receiving, etc., of the signal. Wireless access technologies involved with the first radio frequency 170 and the second radio frequency 180 may include LTE, GSM, and GPRS, etc.

When the user device 100 performs data transmission, the data service may be divided into following cases:

(I) Performing Data Transmission Through the First Subscriber Identity Card:

Upload: The application service processor 150 may receive user instructions and control the first processor 130 to process upload data according to the user instructions. The first radio frequency 170 may transmit the upload data processed by the first processor 130 to the first 4G network.

Download: The first radio frequency 170 may receive download data from the first 4G network, and transmit the download data to the first processor 130 for processing. The application service processor 150 may perform output, storage and other operations on the download data processed by the first processor 130.

(II) Performing Data Transmission Through the Second Subscriber Identity Card:

Upload: The application service processor 150 may receive user instructions and control the second processor 140 to process upload data according to the user instructions. The second radio frequency 180 may transmit the upload data processed by the second processor 140 to the second 4G network.

Download: The second radio frequency 180 may receive download data from the second 4G network, and transmit the download data to the second processor 140 for processing. The second processor 140 may transmit the processed download data to the application service processor 150, and, thus, output, storage and other operations may be performed.

(III) Simultaneously Performing Data Transmission Through the First Subscriber Identity Card and the Second Subscriber Identity Card:

Simultaneously performing data transmission through the first subscriber identity card and the second subscriber identity card may include following two cases:

In a first case, different data jobs may be transmitted through the first subscriber identity card and the second subscriber identity card, respectively. In this case, different data jobs may be transmitted through two data channels, respectively, which may greatly improve transmission efficiency.

In a second case, the data may be transmitted simultaneously through the first subscriber identity card and the second subscriber identity card. In this case, data flow allocation may need to be performed. That is, the data may be divided into different data blocks to be transmitted by the two data channels, respectively. It should be understood that the data flow allocation may be implemented by equal allocation, or adjusting data flows of the two channels according to link quality (speed, delay, etc.), etc.

Therefore, the user device in the disclosed embodiments of the present invention may implement acceleration through dual 4G data channels during downloading, video browsing, or other data services. Further, in combination with data flow adjustment, a preferred selection of data channels (selecting a data channel with the best link quality) may be achieved to improve the data transmission efficiency.

Referring to FIG. 2, when performing a voice service, a digital signal processor chip 210 may be configured to perform audio signal processing, e.g., echo suppression, noise suppression, and other audio signal processing during a call. A codec 220 may be configured to perform A/D and D/A conversion. A handset 230 may be configured to output sound signals. A microphone 240 may be configured to collect voice signals.

When the user device 100 performs voice transmission, the voice service may be divided into following cases:

(I) Performing Voice Transmission Through the First Subscriber Identity Card:

First, establishing a voice communication connection: the application service processor 150 may transmit operation instructions to the first processor 130, and send a radio resource control (RRC) connection request and other processes to the first 4G network through the first radio frequency 170 to establish the voice communication connection with a called party.

After establishing the voice communication connection, a voice upload transmission process may include the following: the microphone 240 may collect voice signals, and the codec 220 may receive the collected voice signals and perform analog-to-digital conversion, and transmit the converted signals to the digital signal processor chip 210; the digital signal processor chip 210 may perform audio processing on the received signals and transmit the processed signals to the first processor 130; and the first radio frequency 170 may transmit the signals processed by the first processor 130. A voice download transmission process may include the following: the first radio frequency 170 may receive download signals and transmit the download signals to the first processor 130; the digital signal processor chip 210 may perform audio processing on the signals processed by the first processor 130 and transmit the processed signals to the codec 220; and the codec 220 may perform analog-to-digital conversion on the received signals and transmit the converted signals to the handset 230.

It should be understood that if the user device 100 is a called party, the process of establishing the voice communication connection may include receiving a connection establishment request from a calling party to establish the voice communication connection with the calling party. Subsequent voice upload transmission and download transmission processes may be the same.

(II) Performing Voice Transmission Through the Second Subscriber Identity Card:

First, establishing a voice communication connection: the application service processor 150 may transmit operation instructions to the first processor 130, and send a radio resource control (RRC) connection request and other processes to the second 4G network through the first radio frequency 170 to establish the voice communication connection with a called party.

After establishing the voice communication connection, a voice upload transmission process may include the following: the microphone 240 may collect voice signals, and the codec 220 may receive the collected voice signals and perform analog-to-digital conversion, and transmit the converted signals to the digital signal processor chip 210; the digital signal processor chip 210 may perform audio processing on the received signals and transmit the processed signals to the first processor 130; and the first radio frequency 170 may transmit the signals processed by the first processor 130. A voice download transmission process may include the following: the first radio frequency 170 may receive download signals and transmit the download signals to the first processor 130; the digital signal processor chip 210 may perform audio processing on the signals processed by the first processor 130 and transmit the processed signals to the codec 220; and the codec 220 may perform analog-to-digital conversion on the received signals and transmit the converted signals to the handset 230.

It should be understood that if the user device 100 is a called party, the process of establishing the voice communication connection may include receiving a connection establishment request from a calling party to establish the voice communication connection with the calling party. Subsequent voice upload transmission and download transmission processes may be the same.

(III) Performing Data Transmission Through the Second Subscriber Identity Card while Performing Voice Transmission Through the First Subscriber Identity Card:

In this case, the process of performing voice transmission through the first subscriber identity card and the process of performing data transmission through the second subscriber identity card may be performed at the same time, which are not repeated herein.

(IV) Performing Data Transmission Through the Second Subscriber Identity Card while Performing Voice Transmission Through the Second Subscriber Identity Card:

In this case, the process of performing voice transmission through the second subscriber identity card and the process of performing data transmission through the second subscriber identity card may be performed at the same time, which are not repeated herein.

In the disclosed embodiments of the present invention, the first processor 130 may further perform in-place detection on the first subscriber identity card 120 and on the second subscriber identity card 121 at regular intervals. Specifically:

The first processor 130 may communicate with the first subscriber identity card 120 and the second subscriber identity card 121 once every preset-time-period (e.g., 28 seconds) to confirm whether the subscriber identity cards are in place and to ensure normal communication. For example, the first processor 130 may send null data to the first subscriber identity card 120 and the second subscriber identity card 121, respectively, if a response is obtained, it may be confirmed that the subscriber identity card is in place, otherwise, the subscriber identity card may be not in place.

Referring to FIG. 2, in the disclosed embodiments of the present invention, both of the two subscriber identity cards may be connected to the first processor 130 in a hardware structure. In one embodiment, the first processor 130 may be connected to the first subscriber identity card 120 and the second subscriber identity card 121 through UART data interfaces, respectively, to perform information read and write operations on the first subscriber identity card 120 and the second subscriber identity card 121.

The second processor 140 may obtain the information of the subscriber identity card through exchange with the first processor 130. Specifically, in one embodiment of the present invention, the first processor 130 may be connected to the second processor 140 through a data interface (e.g., a UART data interface) to transfer information of the subscriber identity card to the second processor 140.

To implement the card information exchange between the first processor 130 and the second processor 140, a communication protocol between the first processor 130 and the second processor 140 may be divided into a physical layer, a transmission layer, and an application layer. Further, the physical layer may be used to send and receive data. The transmission layer may extend a plurality of interfaces, which may be used for corresponding different services enabled by the application layer, respectively. The application layer may be used to enable services to perform corresponding information acquisition functions.

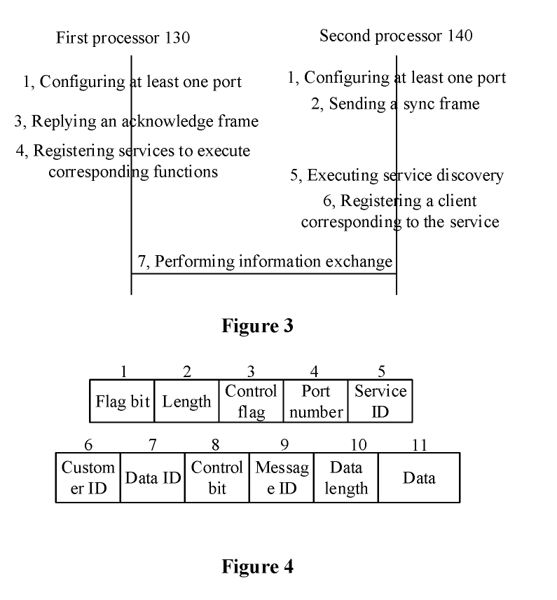

Specifically, referring to FIG. 3, the first processor 130 and the second processor 140 may be configured with at least one port, respectively. In the disclosed embodiments of the present invention, the port may be a virtual logical port, and configuring the port may include setting a port number for the port, etc. According to functions, the port may be divided into two types. The first type may be a port corresponding to a service registered by the application layer, and may transmit information obtained by the service of the application layer to the transmission layer. The second type may be a port corresponding to a physical interface of the physical layer, and may transmit information to the corresponding physical interface, thereby implementing the transmission (or reception) of information.

Specifically, the first processor 130 may register services to execute corresponding functions. In the disclosed embodiments of the present invention, the service may be a preset service. For example, obtaining the card information may be used as a preset service. When a preset condition is satisfied, after the second processor establishes a connection with the first processor by sending a synchronization frame, the first processor may register the preset service to perform the function of the preset service. In one embodiment of the present invention, the preset service may be obtaining information of the subscriber identity card.

In the disclosed embodiments of the present invention, different services may have different functions. For example, a service for obtaining card information may be registered. Other types of services, e.g., services for obtaining status information, control information, etc., may also be registered in the disclosed embodiments of the present invention. Each one service may correspond to one port, that is, information obtained by the service may be transmitted through a port corresponding to the service. The port here may be referred to the first-type port described above.

Therefore, in the disclosed embodiments of the present invention, because a plurality of ports (the first-type ports described above) may be extended to correspond to different services, respectively, and different transmission layers may be invoked according to actual communication transmission demands to transmit information to interfaces of the physical layer (e.g., a USB interface, a shared memory interface, etc.) to support extending a plurality of transmission layer protocols. For example, for a first service, a transmission layer 1 may be invoked to transmit information, and for a second service, a transmission layer 2 may be invoked to transmit information. Different transmission layers may use different transmission layer protocols.

The second processor 140 may send a sync frame (synchronization frame) to the first processor 130. The first processor 130 may be further configured to reply an acknowledgement frame (ACK) after receiving the sync frame to establish a connection between the first processor 130 and the second processor 140. In the disclosed embodiments of the present invention, when a preset condition is satisfied, the second processor 140 may initiate the connection establishment process, that is, may send the sync frame. The preset condition may include boot, restart, and other performing initialization moments.

It should be understood that in the disclosed embodiments of the present invention, there is no sequential order in establishing the connection between the first processor 130 and the second processor 140 through sync and ACK and registering the service by the first processor 130. The first processor 130 may register the service either before or after establishing the connection.

The second processor 140 may execute service discovery and register a client corresponding to the service. In one embodiment, the client registered by the second processor 140 may correspond to the service registered by the first processor 130. Further, similar to the service registered by the first processor 130, the client registered by the second processor 140 may correspond to a corresponding port to transmit information to the transmission layer through the port, and to transmit the information to a corresponding physical interface through the port of the transmission layer.

After the second processor 140 registers the client, the first processor 130 and the second processor 140 may perform information exchange. Specifically, when performing the information exchange, a data packet format as shown in FIG. 4 may be used. The data packet format may include a flag bit (packet header part), a length (the length of the entire packet), a control flag (indicating a client or a server), a port number (local port), a service ID, a customer ID, a data ID, a control bit, a messages ID, a data length, and data.

In one embodiment of the present invention, the port number may be a port number of the second-type port described above, which may be used to mark to which physical interface the data packet is transmitted. For example, when the physical interfaces include a USB interface and a shared memory interface, the data packet may be correctly transmitted to the corresponding physical interface through the port number to implement the information exchange with the second processor 140. Therefore, after the data packet is transmitted to the physical layer, the field of port number may be deleted. That is, the data packet transmitted to the opposite end may not include the field of port number.

In one embodiment of the present invention, different physical interfaces (hardware interfaces) may have different port numbers. Therefore, by assigning a port number in the data packet, the data packet may be correctly forwarded, such that the information obtained by the service registered by the application layer may be transmitted through the exact physical interface. Therefore, the dual-core communication device in the disclosed embodiments of the present invention may support extending a plurality of physical interfaces (e.g., extending a plurality of physical layer protocols).

The service ID may be an ID number of the registered service. The client ID may be an ID number of the client corresponding to the service. The control bit may be used to identify whether the data packet is a request packet, a reply packet, etc. The data may use a ‘type-len-value’ format, where ‘type’ may be used to represent a type of the entire data block, ‘len’ may be used to represent a size of the ‘value’ field, and ‘value’ may be the data field.

In disclosed embodiments of the present invention, one service may have to transmit a plurality of data packets, and, thus, the message ID may represent a sequence number of the transmitted data packet. The data ID may be used to distinguish message type of the data packet. Each data packet may include a plurality of data with different types, thus, one message ID may correspond to a plurality of types. For example, a signal strength, a network format, and other information may be transmitted as one data packet, and types of different data blocks may be represented in the data field by ‘type’. Therefore, one data packet may transmit various information belonging to a same one message type.

It should be understood that the data packet format illustrated in FIG. 4 is merely exemplary, and other similar formats may be used.

In one embodiment of the present invention, specifically, the first processor 130 may be configured with a first logical port corresponding to a preset service, and configured with a second logical port corresponding to a physical interface of the first processor. Information obtained by the preset service may be transmitted to the second logical port through the first logical port, and then transmitted to the second processor through the physical interface of the first processor. The second processor 140 may be configured with a third logical port corresponding to a client, and configured with a fourth logical port corresponding to a physical interface of the second processor. Information received by the physical interface of the second processor may be transmitted to the third logical port through the fourth logical port, and then transmitted to the client.

In the disclosed embodiments of the present invention, when the second processor 140 shuts down or abnormally restarts, the second processor 140 may close the client and the ports. When the second processor 140 returns to normal, the connection with the first processor 130 may be re-established by sending a sync frame to re-execute the processes of registering the service, registering the client, etc., and to perform information exchange.

Similarly, if the first processor 130 shuts down or abnormally restarts, the first processor 130 may close the corresponding service and ports. When the first processor 130 returns to normal, the connection with the second processor 140 may be re-established by sending a sync frame to re-execute the processes of registering the service, registering the client, etc., and to perform information exchange.

In the dual-core communication device in the disclosed embodiments of the present invention, a C/S communication architecture may be adopted between the first processor and the second processor to share information. Therefore, the first processor 130 may share the obtained information with the second processor 140, and, thus, the second processor 140 may obtain the information instantly. Further, different ports may be registered for different services to perform corresponding transmission, which may support extending a plurality of transmission layer protocols and support extending a plurality of physical layer protocols.

After the second processor obtains the information of the subscriber identity card by using the subscriber identity card information sharing scheme described above, a network search and registration process may include:

In one embodiment of the present invention, the first subscriber identity card may be used as a primary card, and the second subscriber identity card may be used as a secondary card. Then, when searching and registering the network, the first processor may obtain the information of the first subscriber identity card, and load network parameters corresponding to the first subscriber identity card according to the obtained information, to register CS voice service and PS data service of the first subscriber identity card in the first network. The first processor may further obtain information of the second subscriber identity card, and load network parameters corresponding to the second subscriber identity card according to the obtained information, to register CS voice service of the second subscriber identity card in the first network.

The first processor may further send the obtained information of the second subscriber identity card to the second processor. The second processor may register PS data service of the second subscriber identity card in the second network according to the received information of the second subscriber identity card.

In addition, the second processor may further perform read and write operations on the first subscriber identity card and/or the second subscriber identity card.

The user device in the disclosed embodiments of the present invention may support dual 4G subscriber identity cards, where a data service and a voice service of one subscriber identity card may be implemented by the first processor, a data service of the other one subscriber identity card may be implemented by the second processor, and a voice service of the other one subscriber identity card may be implemented by the first processor, to improve user experience. Dual 4G may be supported for data transmission service. As one card performs 4G transmission, the other one card may perform CS voice; or as one card performs 4G transmission and voice, the other one card may also perform 4G transmission, etc., greatly improving the data transmission speed and user experience. Two subscriber identity cards may be simultaneously managed by the first processor, and the second processor may obtain the information of the subscriber identity card by sharing the card information. One application service processor may be needed to interact with the first processor and the second processor, thereby saving costs and improving performance.

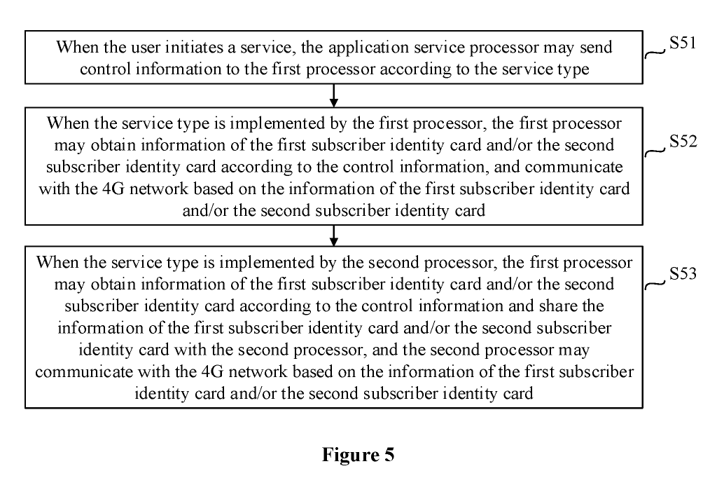

Referring to FIG. 5, the disclosed embodiments of the present invention provide a communication method, including:

S51: When the user initiates a service, the application service processor may send control information to the first processor according to the service type.

S52: When the service type is implemented by the first processor, the first processor may obtain information of the first subscriber identity card and/or the second subscriber identity card according to the control information, and communicate with the 4G network based on the information of the first subscriber identity card and/or the second subscriber identity card.

S53: When the service type is implemented by the second processor, the first processor may obtain information of the first subscriber identity card and/or the second subscriber identity card according to the control information and share the information of the first subscriber identity card and/or the second subscriber identity card with the second processor, and the second processor may communicate with the 4G network based on the information of the first subscriber identity card and/or the second subscriber identity card.

The information of the subscriber identity card may include at least one of the following: a unique serial number, an international mobile subscriber identity, security authentication and encryption information, temporary information related to a local network, a user access list of services, a personal identity number (PIN), and a personal unlocking key for PIN unlocking.

The service type may include at least one of following types: a data service performed by the first subscriber identity card, a voice service performed by the first subscriber identity card, a data service performed by the second subscriber identity card, and a voice service performed by the second subscriber identity card. If the service type is the voice service performed by the first subscriber identity card, the first processor may obtain the information of the first subscriber identity card according to the control information, and communicate with the 4G network based on the information of the first subscriber identity card. If the service type is the voice service performed by the second subscriber identity card, the first processor may obtain the information of the second subscriber identity card according to the control information, and communicate with the 4G network based on the information of the second subscriber identity card. If the service type is the data service performed by the first subscriber identity card, the first processor may obtain the information of the first subscriber identity card according to the control information, and communicate with the 4G network based on the information of the first subscriber identity card.

It should be understood that the foregoing merely shows a case where the service type is a single form. When the service type is a combined case, a combination of the foregoing embodiments may be performed, which are not repeated herein.

The implementation details and principles of the user device in the above embodiments are also applicable to the communication method in the disclosed embodiments of the present invention, which are not repeated herein.

The user device and communication method in the disclosed embodiments of the present invention may support dual 4G subscriber identity cards, where a data service and a voice service of one subscriber identity card may be implemented by the first processor, a data service of the other one subscriber identity card may be implemented by the second processor, and a voice service of the other one subscriber identity card may be implemented by the first processor, to improve user experience. Dual 4G may be supported for data transmission service. As one card performs 4G transmission, the other one card may perform CS voice; or as one card performs 4G transmission and voice, the other one card may also perform 4G transmission, etc., greatly improving the data transmission speed and user experience. Two subscriber identity cards may be simultaneously managed by the first processor, and the second processor may obtain the information of the subscriber identity cards by sharing the card information. One application service processor may be needed to interact with the first processor and the second processor, thereby saving costs and improving performance.

The user device in the disclosed embodiments of the present invention may include any mobile, portable computing or communication device, e.g., a cellular device, capable of connecting with a network. For example, the user device may be a cellular phone (mobile phone), a navigation system, a computing device, a camera, a PDA, a music device, a game device, or a handheld device with wireless connection capabilities.

In the disclosed embodiments of the present invention, the 4G network is mainly described as an LTE network, and other types of 4G networks may be applicable to the present invention. In subsequent embodiments of the present invention, the first 4G network and the second 4G network may be different networks of different operators, or may be same or different networks of a same operator.

In the disclosed embodiments of the present invention, ‘plurality’ refers to two or more unless otherwise specified. In the description of the present invention, it should be understood that terms ‘first’, ‘second’, etc. are merely used for descriptive purposes and are not to be construed as indicating or implying relative importance.

It should be noted that, in the present context, terms ‘include’, ‘including’, or any other variations thereof are intended to cover non-exclusive inclusions, such that a process, method, article, or device that includes a series of elements includes not merely those elements, but also includes other elements that are not explicitly listed, or further includes elements that are inherent to such process, method, article, or apparatus. In the case of no more limitation, the element defined by the sentence ‘includes a . . . ’ does not exclude that additional same elements exist in the process, method, article, or apparatus.

The sequence numbers in the foregoing embodiments of the present invention are merely for description purposes and do not represent the advantages and disadvantages of the embodiments.

In the plurality of embodiments provided in this application, it should be understood that the disclosed devices and method may be implemented in other manners. The device embodiments described above are merely schematic, for example, the division of the units is merely a logical function division, and actual implementation may have other division manners. For example, a plurality of units or components may be combined, or may be integrated into another system, or some features may be ignored or not performed. In addition, the coupling, direct coupling, or communication connection of the displayed or discussed components with each other may be achieved through some interfaces, and indirect coupling or communication connection of the devices or units, may be electrical, mechanical, or other forms.

The units described as separate parts may be or may not be physically separated, and parts described as display units may be or may not be physical units, that is, may be located in one place, or may be distributed on a plurality of network units. Some or all of units may be selected according to actual demands to achieve the purpose of the scheme of the disclosed embodiments.

In addition, each functional unit in each embodiment of the present invention may be entirely integrated into one processing unit, or each unit may be separately used as a unit, or two or more units may be integrated into one unit. The integrated unit may be implemented either in hardware or hardware plus software functional units.

Persons of ordinary skill in the art can understand that all or part of the steps for implementing the above method embodiments can be accomplished through program instructions related hardware. The aforementioned program can be stored in a computer-readable storage medium. When the program is executed, the steps including the above method embodiments are executed. The foregoing storage medium includes: a mobile storage device, a read-only memory (ROM), a random-access memory (RAM), a magnetic disk, an optical disk, or various media that can store program code.

Alternatively, when the above-described integrated units in the present invention are realized through software functional units, and are sold and used as independent products, the integrated units may be stored on computer readable storage media. Based on this understanding, the essential of the technical solution in the disclosed embodiments of the present invention or the part that contributes to the prior art may be embodied in software products. The computer software products may be stored in storage media and may include a plurality of commands to instruct a computer system (such as personal computer, server, network system, etc.) to execute all or a part of the procedures described in various embodiments. The storage media described above may include a mobile storage disk, a ROM, a RAM, a magnetic disk, an optical disk, or various media that can store program code.

The above description is merely the specific implementation manner of the present invention, but the protection scope of the present invention is not limited thereto. Any person skilled in the art can easily think of the change or the replacement within the technical scope disclosed by the present invention, which should be covered by the protection scope of the present invention. Therefore, the protection scope of the present invention shall be subject to the protection scope of the claims.

### INDUSTRIAL APPLICABILITY

The disclosed embodiments of the present invention may support dual 4G subscriber identity cards, where a data service and a voice service of one subscriber identity card may be implemented by the first processor, a data service of the other one subscriber identity card may be implemented by the second processor, and a voice service of the other one subscriber identity card may be implemented by the first processor, to improve user experience. Dual 4G may be supported for data transmission service. As one card performs 4G transmission, the other one card may perform CS voice; or as one card performs 4G transmission and voice, the other one card may also perform 4G transmission, etc., greatly improving the data transmission speed and user experience. Two subscriber identity cards may be simultaneously managed by the first processor, and the second processor may obtain the information of the subscriber identity cards by sharing the card information. One application service processor may be needed to interact with the first processor and the second processor, thereby saving costs and improving performance.

1. A communication method, comprising:
receiving, by a first processor, control information sent from an application service processor according to a service type when a user initiates a service;
when the service type is implemented by the first processor, according to the control information, obtaining, by the first processor, information of one or more of a first subscriber identity card and a second subscriber identity card and communicating with a 4G network based on the information of one or more of the first subscriber identity card and the second subscriber identity card; and
when the service type is implemented by a second processor, according to the control information, obtaining, by the first processor, the information of one or more of the first subscriber identity card and the second subscriber identity card and sharing the information of one or more of the first subscriber identity card and the second subscriber identity card with the second processor; and communicating, by the second processor, with a 4G network based on the information of one or more of the first subscriber identity card and the second subscriber identity card.

2. The method according to claim 1, wherein:
the information of the first subscriber identity card or the second subscriber identity card includes at least one of: a unique serial number, an international mobile subscriber identity, security authentication and encryption information, temporary information related to a local network, a user access list of services, a personal identity number (PIN), and a personal unlocking key for PIN unlocking.

3. The method according to claim 1, wherein:
the service type includes at least one of: a data service performed by the first subscriber identity card, a voice service performed by the first subscriber identity card, a data service performed by the second subscriber identity card, and a voice service performed by the second subscriber identity card.

4. The method according to claim 3, wherein:
when the service type is the voice service performed by the first subscriber identity card, the first processor obtains the information of the first subscriber identity card according to the control information, and establishes a 4G network voice communication connection based on the information of the first subscriber identity card.

5. The method according to claim 3, wherein:
when the service type is the voice service performed by the second subscriber identity card, the first processor obtains the information of the second subscriber identity card according to the control information, and establishes a 4G network voice communication connection based on the information of the second subscriber identity card.

6. The method according to claim 3, wherein:
when the service type is the data service performed by the first subscriber identity card, the first processor obtains the information of the first subscriber identity card according to the control information, and establishes a 4G network data communication connection based on the information of the first subscriber identity card.

7. The method according to claim 3, wherein:
when the service type is the data service performed by the second subscriber identity card, the first processor obtains the information of the second subscriber identity card according to the control information and shares the information of the second subscriber identity card with the second processor, and the second processor establishes a 4G network data communication connection based on the information of the second subscriber identity card.

8. The method according to claim 1, further including:
the first processor communicates with the first subscriber identity card and the second subscriber identity card every preset time-period to confirm whether the first subscriber identity card and the second subscriber identity card are in a normal communication state.

9. A user device, comprising:
an application service processor;
a first processor connected to the application service processor;
a second processor connected to the application service processor;
a first subscriber identity card connected to the first processor; and
a second subscriber identity card connected to the first processor, wherein:
when a user initiates a service, the application service processor is configured to send control information to the first processor according to a service type,
when the service type is implemented by the first processor, according to the control information, the first processor is configured to obtain information of one or more of the first subscriber identity card and the second subscriber identity card and to communicate with a 4G network based on the information of one or more of the first subscriber identity card and the second subscriber identity card,
when the service type is implemented by the second processor, according to the control information, the first processor is configured to obtain the information of one or more of the first subscriber identity card and the second subscriber identity card and to share the information of one or more of the first subscriber identity card and the second subscriber identity card with the second processor, and
the second processor is configured to communicate with a 4G network based on the information of one or more of the first subscriber identity card and the second subscriber identity card.

10. The user device according to claim 9, wherein:
the first processor includes a first data interface, and the second processor includes a second data interface connected to the first data interface of the first processor; and
the second processor obtains the information of one or more of the first subscriber identity card and the second subscriber identity card shared by the first processor through the second data interface.

11. The user device according to claim 9, wherein:
the application service processor is connected to the second processor through a universal serial bus (USB) data interface.

12. The user device according to claim 9, wherein:
information of the first subscriber identity card or the second subscriber identity card includes at least one of: a unique serial number, an international mobile subscriber identity, security authentication and encryption information, temporary information related to a local network, a user access list of services, a personal identity number (PIN), and a personal unlocking key for PIN unlocking.

13. The user device according to claim 9, wherein:
the service type includes at least one of: a data service performed by the first subscriber identity card, a voice service performed by the first subscriber identity card, a data service performed by the second subscriber identity card, and a voice service performed by the second subscriber identity card.

14. The user device according to claim 13, wherein:
when the service type is the voice service performed by the first subscriber identity card, the first processor is configured to obtain the information of the first subscriber identity card according to the control information, and to establish a 4G network voice communication connection based on the information of the first subscriber identity card.

15. The user device according to claim 13, wherein:
when the service type is the voice service performed by the second subscriber identity card, the first processor is configured to obtain the information of the second subscriber identity card according to the control information, and to establish a 4G network voice communication connection based on the information of the second subscriber identity card.

16. The user device according to claim 13, wherein:
when the service type is the data service performed by the first subscriber identity card, the first processor is configured to obtain the information of the first subscriber identity card according to the control information, and to establish a 4G network data communication connection based on the information of the first subscriber identity card.

17. The user device according to claim 13, wherein:
when the service type is the data service performed by the second subscriber identity card, the first processor is configured to obtain the information of the second subscriber identity card according to the control information and to share the information of the second subscriber identity card with the second processor, and
the second processor is configured to establish a 4G network data communication connection based on the information of the second subscriber identity card.

18. The user device according to claim 9, wherein:
the first processor is further configured to communicate with the first subscriber identity card and the second subscriber identity card every preset time-period to confirm whether the first subscriber identity card and the second subscriber identity card are in a normal communication state.

19. The user device according to claim 10, wherein:
before obtaining the information of one or more of the first subscriber identity card and the second subscriber identity card shared by the first processor through the second data interface, the second processor is further configured to establish a connection with the first processor.

20. A non-transitory computer-readable storage medium, having computer-executable instructions stored thereon, wherein, when being executed, the computer-executable instructions cause a processor to perform a communication method, the communication method comprising:
when a user initiates a service, sending, by an application service processor, control information to a first processor according to a service type;
when the service type is implemented by the first processor, according to the control information, obtaining, by the first processor, information of one or more of a first subscriber identity card and a second subscriber identity card and communicating with a 4G network based on the information of one or more of the first subscriber identity card and the second subscriber identity card; and
when the service type is implemented by a second processor, according to the control information, obtaining, by the first processor, the information of one or more of the first subscriber identity card and the second subscriber identity card and sharing the information of one or more of the first subscriber identity card and the second subscriber identity card with the second processor; and communicating, by the second processor, with a 4G network based on the information of one or more of the first subscriber identity card and the second subscriber identity card.
